(19) United States
(12) Patent Application Publication
(10) Pub. No.: US 2002/0184337 A1
(43) Pub. Date: Dec. 5, 2002

(54) Method and computer system for constructing references to virtual data

(76) Inventor: Anders Hyldahl, Copenhagen (DK)

Correspondence Address: BIRCH STEWART KOLASCH & BIRCH, PO BOX 747, FALLS CHURCH, VA, 22040-0747, US

(21) Appl. No.: 09/861,615

(22) Filed: May 22, 2001

(30) Foreign Application Priority Data
May 21, 2001 (DK) PA 2001 00816

(51) Int. Cl. G06F 15/16; G06F 17/30; G06F 7/00

(52) U.S. Cl. 709/218; 707/10; 709/203

(57) ABSTRACT

A virtual data argument data, comprising at least one identifier each uniquely identifying one or more items of the virtual data, and at least one descriptor uniquely defining relationship between the item(s) identified by the indentifier(s).

The present invention relates to a method and a computer system enabling referencing to virtual data and in particular to a method and a computer system for constructing a reference to virtual data.

### INTRODUCTION TO THE INVENTION

The present invention concerns referencing of virtual data present in a computer system. In the present context, the term virtual data is preferably used to denote data items which are not explicitly represented in a computer system but which mostly are implicit in the computer system, e.g. data which are not explicit represented but constructed during execution of an application.

When such virtual data are accessed they are typically not referenceable as they typically are the end result of a process most often being unpredictably executed. Furthermore, virtual data, in the present context, will most often depend on the way they are accessed even though the contents of such virtual data in virtue are identical.

Thus, an object of the present invention is to provide a, data structure, a method and a computer system for referencing virtual data, in which each virtual data is uniquely defined and referenceable.

In a first aspect of the present invention a virtual data argument for virtual data is provided. The virtual data argument comprises preferably a data structure holding:

at least one identifier each uniquely identifying one or more items of the virtual data, and

at least one descriptor uniquely defining relation ship between the item(s) identified by the identifier(s).

In preferred embodiments of the invention the virtual data argument the one or more of the at least one identifier(s) comprises document locator(s), such as URL(s) and alternatively or in combination thereto the one or more of the descriptor(s) comprises a set of instructions, such as a container. In particular preferred embodiments the item(s) is(are) web-pages. It is also preferred that at least one of the at least one identifier(s) is a virtual data argument.

In a second aspect the present invention relates to a method of generating a virtual data argument for virtual data. The virtual data argument being preferably characterised in that

the virtual data and/or its content can be constructed from it's virtual data argument, and

the virtual data can be identified by the virtual data argument,

said method comprises conjunction, such as assembling, of at least one identifier identifying one or more item(s) of the virtual data and a descriptor uniquely defining relation ship between the item(s) identified by the identifier(s).

In preferred embodiments the method according to the present invention further comprising the step of progressing, preferably by use of a worm or the like, through a collection of data items, such as documents, and examining some or all of said data items for descriptors and if the examining reveals at least one descriptor a virtual data argument is generated corresponding to said descriptor(s) and the corresponding data items.

Also, the method may preferably further comprising the step of following all or some links, if present, in the collection of data items and examining data items corresponding to said links for descriptors and if the examining reveals at least one descriptor.

In order to be able to identify all link, or substantial all links, it is preferred that the method according to the present invention further comprising the step of examining a virtual data argument for links and if the examining reveals a link a virtual data corresponding to the virtual data being the result of executing said link is generated. If such an examining reveals a link, it is preferred that the virtual data argument and the link is stored in a list of not yet created virtual data arguments.

In a preferred implementation of the method according to the invention the virtual data arguments for the virtual data arguments and corresponding links stored in the list of not yet created virtual data arguments are generated after progressing of the collection is ended.

In order to avoid, or substantial avoid, redundancy of virtual data arguments the method according to the present invention may preferably further comprise the step of examining for virtual data argument having identical descriptors and for such virtual data arguments examining whether the identifier parts contains permutations of the same identifier and in confirmative case taking measures to assure that only one of those virtual data arguments is available, for instance by only storing one of those virtual data arguments.

It is preferred that the virtual data argument is of the data structure according to the first aspect of the present invention.

In a third aspect of the present invention a computer system for generating a virtual data argument for virtual data is provided in which said virtual data argument being preferably characterised in that

the virtual data and/or its content can be constructed from it's virtual data argument, and

the virtual data can be identified by the virtual data argument,

said apparatus comprises preferably means, such as computer processing means, for conjunction of at least one identifier identifying one or more item(s) of the virtual data and a descriptor uniquely defining relation ship between the item(s) identified by the identifier(s).

According to the third aspect of the invention it is preferred that the computer system comprises means for executing one or more of the steps according to the second aspect of the invention.

In a fourth aspect of the present invention a method for constructing a list of virtual data arguments is provided. This method comprises preferably:

providing a first virtual data argument to a first virtual data;

constructing the first virtual data and/or it's content;

extracting, if present, identifier(s) to data item(s) from the first virtual data and/or it's content;

providing a descriptor describing the context of the identifier(s) to data item(s);

conjugating identifier(s) to data item(s) and the corresponding descriptor thereby defining a second virtual data; and

assigning a virtual data argument to the second virtual data.

In a fifth aspect of the invention a computer system for constructing a list of virtual data arguments is provided, which computer system comprises preferably:

means, such as computer processing means, for providing a first virtual data argument to a first virtual data;

means, such as computer processing means, for constructing the first virtual data and/or it's content;

means, such as computer processing means, for extracting, if present, identifier(s) to data item(s) from the first virtual data and/or it's content;

means, such as computer processing means, for providing a descriptor describing the context of the identifier(s) to data item(s);

means, such as computer processing means, for conjugating identifier(s) to data item(s) and the corresponding descriptor thereby defining a second virtual data; and

means, such computer processing means, for assigning a virtual data argument to the second virtual data.

The computer system according to the sixth aspect comprises preferably means, such as computer processing means, for executing one or more of the steps according to the fourth aspect of the invention.

Thus, the identifiers and the descriptors are conjugated, such as assembled, preferably, into a data structure whereby all information needed to reconstruct the virtual data directly available and referenceable.

In general, frames add functionality and easy navigation to a Website by combining separate documents within the same browser window. Typically, one frame is used as a static navigation bar and another frame displays the content. This allows users to scroll through the “content frame” while the “navigation frame” remains in one spot. What appears to be a single “document window” is often a combination of two or more separate documents. These documents within a frame structure can come from different directories, or even be located on different servers

Also, frames add flexibility and freedom to homepage design, but also pose a complex problem for search engines. In order to present “web pages” as intended, search engines must not only index the content of every single document, they must also register all the combinations in which each file is part of a frame structure and the precise layout of each document within each “web page”.

Since this is an extremely complex task, most search engines simply disregard pages authored in frames! Typically these search engines only index content that is found within a tag. This produces one of two results:

1. If you do not use tags on your Website, the search engine will not index the page.

2. If you use tags on your Website, the search engine only provides a link to the document (frame) in which it found a matching word, leaving out the rest of the frame structure; typically users receive a page without navigation and header frame. Your “page” has been stripped down, and it may be impossible for users to see where they are or to navigate further.

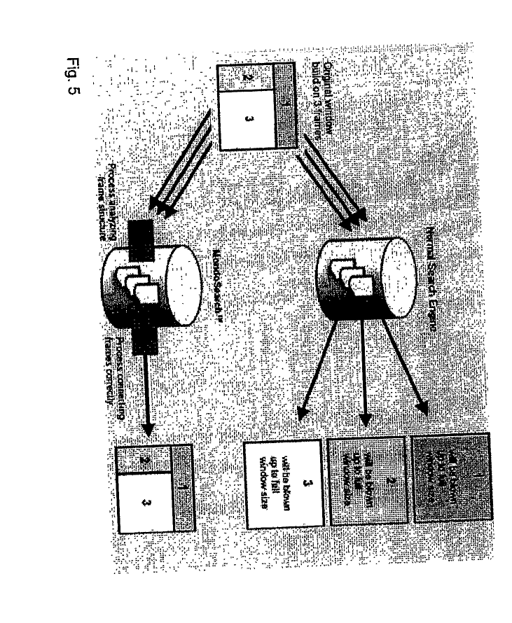

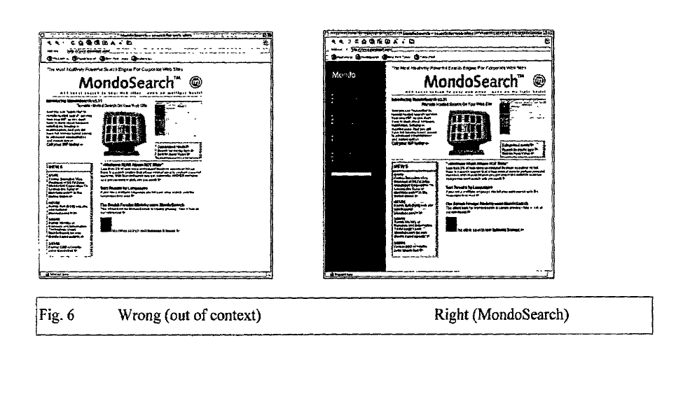

Examples of this is shown in FIG. 5 where the original page that is shown to the user may be displayed in 3 different ways, all wrong compared to the original page contents and layout where the present invention enables e.g. a search engine to reference a page constructed by frames correctly as shown in FIG. 5. FIG. 6 shows an example of a screed dump of

Thus, another object of the present invention is to provide a method and an apparatus capable of handling display of documents in a frame in a manner such that errors in displaying is minimised.

According to a sixth aspect of the present invention, a method for controlling the display of one or more documents in frames within a page is provided, which display being dictated by a set of commands. The method comprises preferably,

detecting whether execution of a command of said set of commands results in splitting a frame into two or more frames,

and in confirmative case

assign a frame depth identifier to each of the frames into which the original frame are split.

According to a seventh aspect of the present invention a computer system for controlling the display of one or more documents in frames within a page is provided, which display being dictated by a set of commands. The computer system comprises preferably

detecting means, such as computer processor means, for detecting whether execution of a command of said set of commands results in splitting a frame into two or more frames,

and computer processor means instructed to, in confirmative case,

assign a frame depth identifier to each of the frames into which the original frame are split.

It is preferred that computer systems according to the seventh aspect further comprises means, such as computer processing means, for executing one or more of the steps defined in any of the sixth aspect of the present invention.

By the feature frame depth it has been rendered possible to keep track of the positions within the frame and thereby a basis for decision making on whether a document can be displayed at a position has been established.

### DETAILED DESCRIPTION OF PREFERRED EMBODIMENTS OF THE INVENTION

In the following the invention, and in particular preferred embodiments thereof, will be described in details with reference to the accompanying drawings which:

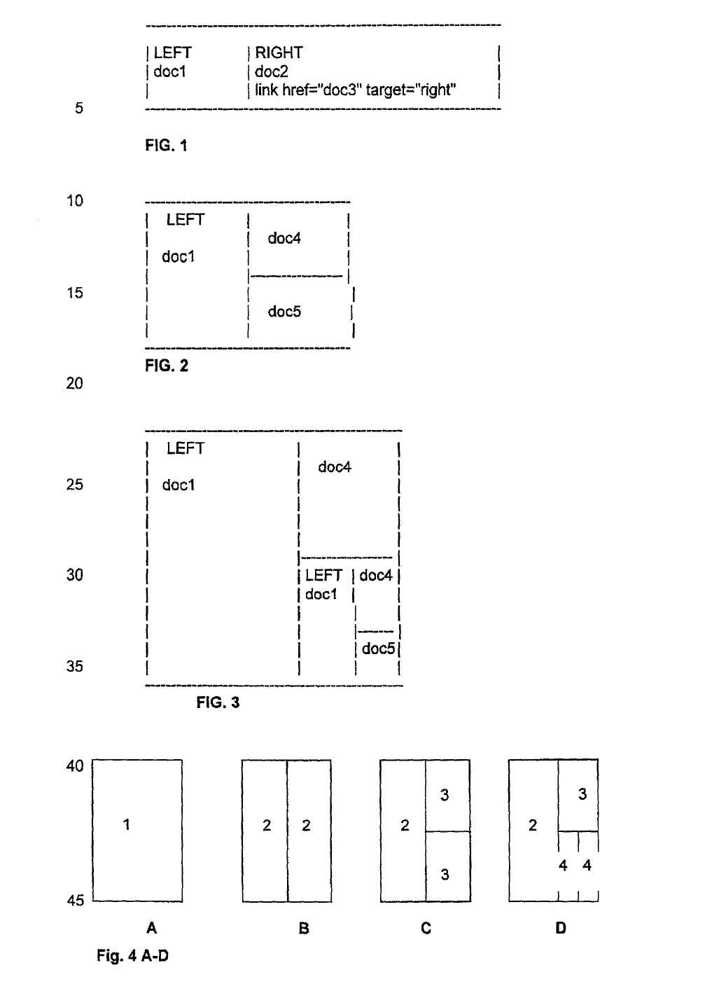

FIG. 1 shows schematically a frame structure;

FIG. 2 shows schematically an evolution of the frame structure in FIG. 1;

FIG. 3 shows schematically an example of repetitions or nested duplicates within a frame;

FIG. 4 shows schematically an example of the concept of frame depth;

FIG. 5 shows schematically handling of frames by prior art systems (labelled Normal Search Engine) and the present invention (labelled as MondoSearch™);

FIG. 6 shows a result of a search engine not storing the frame information, whereby found pages appear out of context, for example, without important navigation controls,

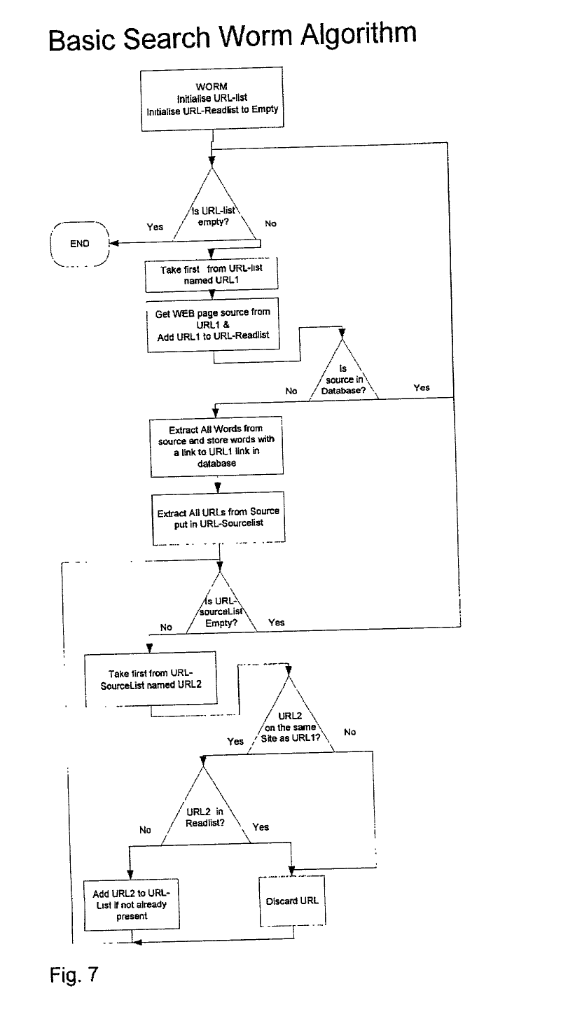

FIG. 7 shows an example of a basic search worm algorithm;

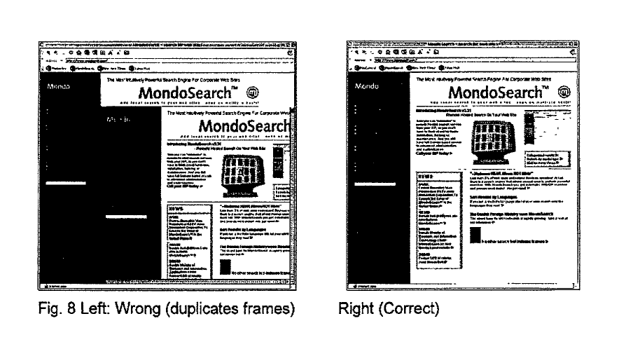

FIG. 8 shows an example that incorrect links created by page designers or generated by search engines can create duplicate nested frames;

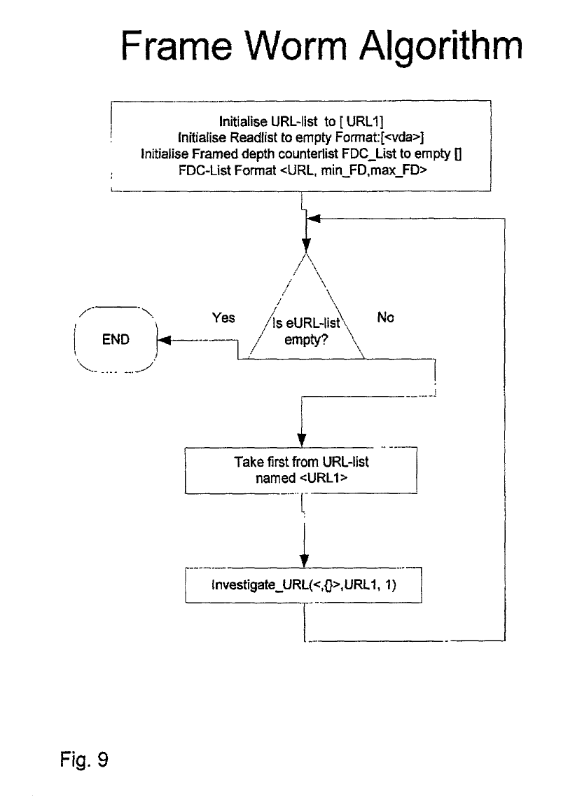

FIG. 9 shows a flow chart for a frame worm algorithm according to preferred embodiments of the present invention;

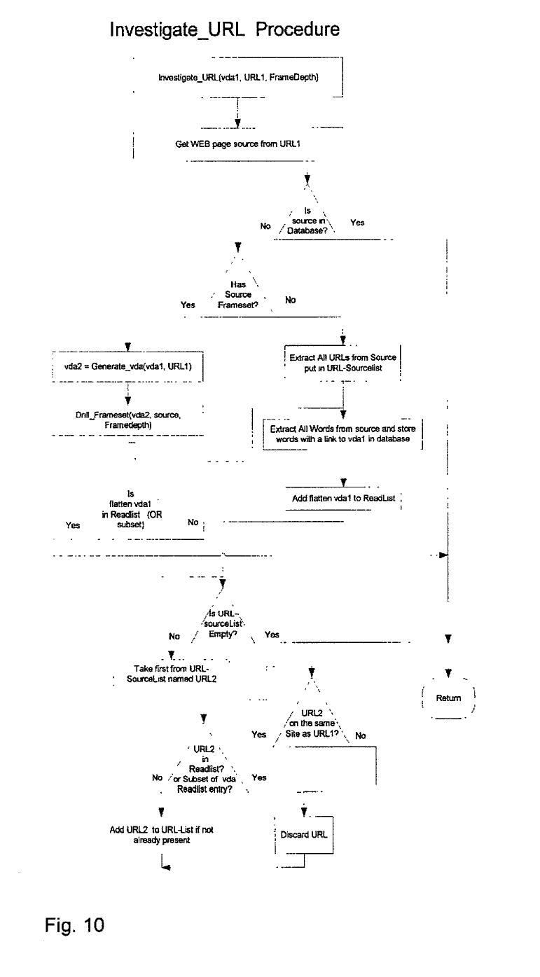

FIG. 10 show a flow chart for a Investigate_URL Procedure according to preferred embodiments of the present invention;

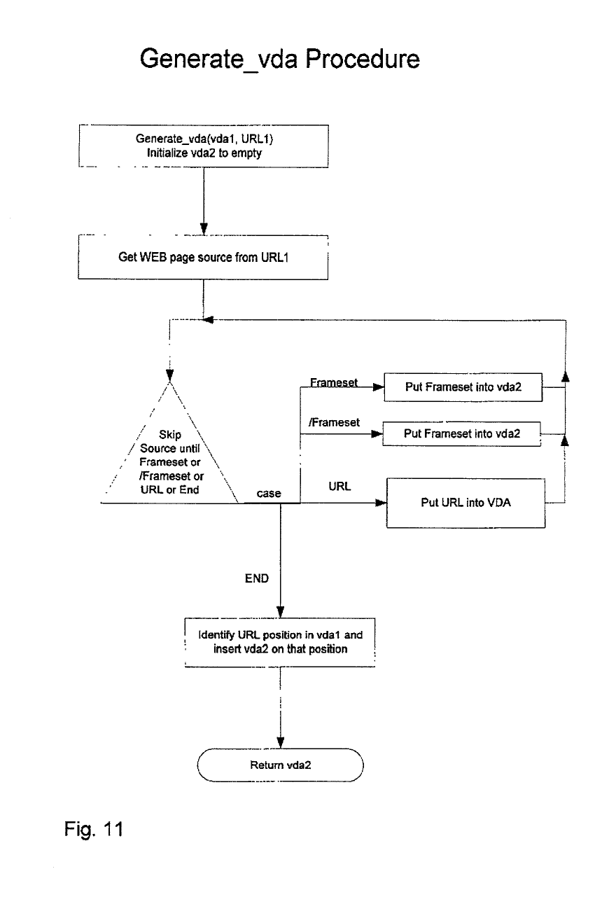

FIG. 11 shows a flow chart for a Generate_vda Procedure according to preferred embodiments of the present invention; and

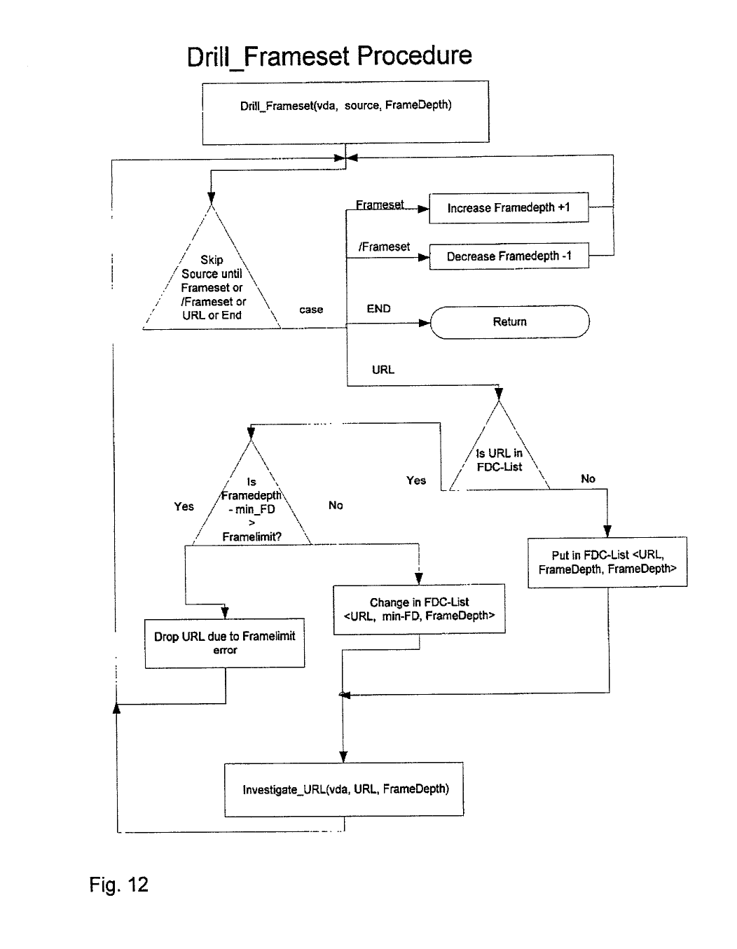

FIG. 12 shows a flow chart for a Drill_Frameset Procedure according to preferred embodiments of the present invention.

More specifically, the process of providing arguments to virtual data and the concept of frame depth will now be described in connection with documents on a web-site. It should be obvious to those skilled in the art that even though the invention is described in connection to web-sites and web-pages, the invention is also very well applicable in other environments as well.

In general, documents (web-pages) are referenced by an URL which contains the path to a web-page. In many practical situations, the web-page is not displayed alone but more than one web-page are shown in a frame (of course one web-page only may be shown in a frame).

In the present context, the term frame is used to denote a screen image divided into panels each of which contains information which may be replaced independently of the content of the other panels. An example of one such frame is shown in FIG. 1, which example will be described in details below.

An example of a frame comprising two panels may typically be described by the following set of instructions (CONTAINER 1):

<frameset col=50%>

<frame src=“doc1l”name=“LEFT”>

<frame src=“doc2”name=“RIGHT”>

</frameset>

which set of instructions corresponds to a frame having appearance as outlined in FIG. 1.

By the statement {link href=“doc3” target=“right”} it is indicated that document 2 {doc 2} contains a link to another document which, in case it is accessed, is to be displayed in the right panel instead of doc 2.

The link to doc 3 may be a link to a single document whereby this document substitutes doc 2 in case the link is accessed. In another situation, the link may be a link to a container containing for instance the following instructions (CONTAINER 2).

<frameset row=50% >

<frame src=doc4>

<frame src=doc5>

</framset>

By executing this set of instructions the initial frame will be altered into the frame disclosed in FIG. 2.

By this operation, accessing the link in doc 2, the frame with content of FIG. 2 is no longer referencable as CONTAINER 1 has been modified and the modification is not stored or tracked. Accordingly, the frame is only reconstructable if the sequence described above is executed. This is clearly very disadvantageously as, for instance, no link can be provided to the frame with content of FIG. 2, which results in that the frame can not be found via a search routine etc. Due to the fact that the frame is not referencable and not directly reconstructable the frame is named virtual data.

Displaying of a frame (the content of the frame) is taken care of by a browser, which is instructed to display the frame and its content by commands. Actually, the browser is, in prior art systems, not directly instructed to display a frame with content but is instructed to reference a database, which referencing either results in return of an URL or a frame container.

In case the browser is instructed to retrieve information, for instance instantiated by a mouse click, the browser will reference a database containing references to data to be retrieved and displayed. In some situations the browser receives an URL to a document where after that particular document are located and displayed in the frame. With the result as in FIG. 5 and FIG. 6.

In a more complex situation, the browser of prior art systems receives a frame container containing information on which documents are to be displayed and how these documents are to be displayed. In this case the browser extracts the URL's from the container and locates these documents in a succeeding step and based on the information on how to display the individual document, the frame is constructed/displayed. This implies that even though the information requested occurs on document 5 it is the page in FIG. 1 that is displayed and the user can not see the requested information and has no clue to where to find it from.

In accordance with one of the object the present invention virtual data argument is provided for a function (a browser) which generates the virtual data, i.e. the function (browser) supplied with the argument renders the virtual data constructable. Such an argument should fulfil the following conditions:

the argument should be unique

the argument should be adequate

optionally, the argument should be of the same nature as ordinary arguments (ordinary input to the browser)

In this way of dealing with data items, the browser (in case the invention is applied in an environment utilising a browser, of course) is considered to be a function which may be provided with arguments. Based on the arguments the function (the browser) will perform some pre-defined steps, such as retrieve a specific document and display that document. In a simplified mathematical analogy, this retrieve-display process may be described as:

y=f(x),

in which x is a reference to a document, f is the functionality of the browser function and y is the screen picture, i.e. the virtual data. In conventional browser systems, the function, f, has been adapted to function in a specific way based on for instance the content of a frame container.

If x contains a link to a document and that link is executed—as described above—y will be modified to y₁. This may be written as

y₁=f(g(x))

which function f(g(x)) is no longer explicit available, but is only reconstructable by following the same sequence which led to y₁ at first hand. Accordingly, y₁ can not be constructed directly, but only via a sequence of execution steps.

In the presently most preferred embodiment this problem has been solved by constructing virtual data arguments in such a manner that once inputted to the browser, f, the virtual data can be constructed. Accordingly, virtual data arguments are of the form

(identifier; descriptor)

which in accordance with the above described mathematical analogy results in

y₁=f(x,g(x)),

in which g(x) is explicit represented in the virtual data argument.

With reference to the above described example, x,g(x) (the virtual data argument) may more specifically be written as

(URL_{—}1,URL_{—}2,URL_{—}3;container)

indicating that the identifier part of the reference comprises references to documents, the URL's, and descriptor part of the reference comprises mutual relation ship between the document (the container). When the virtual data argument is constructed in this manner the browser will be able to construct the virtual data directly.

Following the example above, the virtual data argument of FIG. 2 above is accordingly

(URL_{—}1,URL_{—}4,URL_{—}5,<frame . . . >)

wherein URL_{—}1 corresponds to doc1 etc, and frame . . . > comprises the mutual relation ships between the documents, i.e. the instructions

<frameset col=50% >

<frame src=“doc1” name=“LEFT”>

<frame src=“<frameset row=50% >

<frame src=doc4>

<frame src=doc5>

</framset>”>

</frameset>

The vda for the vda for FIG. 2 extracted from the seven statements:

(doc1, doc4, doc5; <frameset col=50% . . . /frameset>)

In the preferred embodiment of the invention, the virtual data arguments are constructed in the following manner when web-pages are considered.

In connection with the invention a search engine stores all of the information contained on the target site (or sites) in a searchable database. The database is created by a worm program, which loads each page from the site and saves the text content. The worm progresses through the site by following all of the links it finds on each page. This technique for crawling a site is common, though the terminology varies; indexing programs are typically called “worms”, “crawlers”, “spiders”, or “robots”. For a basic algorithm of a worm see FIG. 7

When frames are used, a “frame container” page establishes the size and position of each frame and identifies other HTML documents, which are loaded into the various frames. Most crawlers ignore this frame-set page because it does not contain any visible text. However, because the documents have been designed to appear in frames, the information is stored out of context. When a user views the document by following a link provided by the search engine, only a part of the original page appears.

For each document indexed the worm stores information about the frame set in which it appears, this is what the vda is used for. This assures that when a user follows a link provided by the search engine, the full frame-set page appears with the found content shown in its original context.

As known, web-pages are located during crawling of a web-site. During such a crawling process, the content of each web-page is examined in order to identify the nature of the pages, i.e. whether a page contains instructions and in such cases also the kind of the instructions. If a web-page is found that contains a container, the corresponding frame is constructed as well as the virtual data argument of that frame.

For instance, if the frame of FIG. 1 is identified the virtual data argument vda₁=(doc1, doc2; <frameset . . . /frameset>) is constructed and placed in a virtual data argument table. As vda₁ contains a link to another document optionally displayed in the same frame, that link and vda₁ is placed in a list of not yet created virtual data arguments. During the crawling process, the virtual data argument table and the list of not yet created virtual data arguments will expand as new items will be added.

When the crawling process is finished, processing of the items of the list of not yet created virtual data arguments takes place. Following the example of FIGS. 1 and 2 this processing will include construction of the virtual data of FIG. 2 and the corresponding virtual data argument vda₂=(url_{—}1, url_{—}4, url_{—}5; <frame . . . /frameset>) is constructed and it is checked whether vda₂ is all ready is present in the table of virtual data arguments.

Different criterion may be set-up to define whether a virtual data argument is all ready present in the table of virtual data arguments. These criterions are based on how “uniqueness” of the vda is defined. Preferably, two virtual data are said to be one virtual data, under the proviso that the descriptor parts of the vda's are identical, if the identifier parts of the vda's contain permutations of the same documents. For instance, the following vda's are considered to be arguments to the same virtual data:

(url_{—}1, url_{—}2, url_{—}3; container)=(url_{—}2, url_{—}3, url_{—}1; container).

Accordingly, if the vda in question or a vda containing an identical descriptor part and permutations of identifiers are present in the table of virtual data arguments the vda in question is not added to the table or if no such vda is present in the table the vda is added to the table.

This procedure will make all virtual data explicit represented.

Page Generation

In a particular preferred embodiment of the present invention vda's like the one below for the page regeneration are utilised.

vda₂=(url_{—}1, url_{—}4, url_{—}5; <frame . . . /frameset>)

Even though the generated page will look correct some of the links on the page may be broken because they refer to the some of the framesets that has been eliminated which may cause an incorrect page appearance E.g. omitting e.g. the top frameset.

Thus, an important extension can be made according to the present invention namely that a vda may have to be stored nested in order to make the retrieval process correct. E.g.

vda₁=(url1, vda₂, <frameset . . . /frameset>)

vda₂=(url_{—}4, url_{—}5; <frame . . . /frameset>)

Where as the flattened version presented above E.g.

vda₁=(url_{—}1, url_{—}4, url_{—}5; <frame . . . /frameset>)

is very important in order to recognize duplicates during the crawling process the nested version is very important in order to recreate a page set that does not have the problems with links that refers to framesets that does not exists.

Frame Depth

A common problem seen on frame-based sites results when a full frame set, which is intended to take up the entire browser window, loads inside an existing frame, as shown in FIG. 4. This problem called nested duplicate frames occurs as a result of incorrectly coded links between frames. This can however be very difficult to avoid with many pages on a site, and occurs frequently on real sites that uses frames. Furthermore, because some designers might use this technique for a special purpose, it can not always be concluded that it actually is an error.

This problem poses an challenge for search engine worms that want to handle frames since such nested references may be expanded indefinitely.

In another aspect of the present invention solution to the problem of repetitions or nested duplicates within a frame is suggested. More specifically, such repetitions are typically in the form as disclosed in FIG. 3.

While such a frame is easily recognised by the user of the system it is not at least easily detected by the prior art browsers as such a frame is the result of execution of a number of steps, such as execution a link which refer back to the original frame, i.e. the link present in doc 5 of FIG. 2 results in retrieving and displaying instead of doc 5 the content of FIG. 2.

In accordance with the present invention, this problem has been solved by introducing the concept of frame depths. Frame depth is a novel and very advantageously feature which when introduced may be use to avoid repetition of virtual data inside a virtual data and may very advantageously be used during building of the table of virtual data arguments as a criterion to judge whether a virtual data argument should be added to the table, i.e. a repetition of a virtual data may be discarded at the moment said virtual data is constructed.

In this preferred embodiment described here, the depth of a frame is defined by the sequence of frames shown in FIG. 4. The sequence depicted in FIG. 4 shows the situation where frame A contains only one panel which is assigned frame depth 1.

Frame B has two panels each having the same vertical dimension as the panel of frame A but different horizontal dimension than the panel of frame A. These two panels are each assigned frame depth 2.

Frame C has one panel having the same vertical and horizontal dimensions as the panel of frame B at frame depth 2 and accordingly this panel is also in frame depth 2. Frame C has also two panel having the same horizontal dimension as the panel of frame A at frame depth 2 but a smaller vertical dimension. Accordingly, these two panels are at frame depth 3.

Frame D has one panel at frame depth 2 and one at frame depth 3. Frame D has also two panels each having the same vertical dimension but a different horizontal dimension as the panels of frame C being at frame depth 3. Accordingly, these panels are at frame depth 4.

By introducing the concept of frame depth the situation depicted in FIG. 3 may easily be avoided by the following measures. Following the discussion above, the frame of FIG. 2 has one panel at frame depth 2 and two panels at frame depth 3. The frame of FIG. 3 has one panel at frame depth 2, one panel at frame depth 3, one panel at frame depth 4 and two panels at frame depth 5.

The situation of FIG. 3 is avoided by allowing, for instance, doc 1 to be displayed only in frame depth one or two. Such rules are preferably consulted while the table of virtual data arguments are constructed whereby the vda corresponding to the frame of FIG. 3 would be excluded from the list as it contains an instruction to display doc 1 at frame depth 2 and depth 4 those difference is larger than the allowed frame depth. Since that clearly violates the above limit the VDA is excluded.

In a preferred embodiment this is implemented by counting frame depths during compilation of the descriptor part of the vda. Following the specific example of FIG. 2 this procedure comprises running through the descriptor part of the vda, i.e. running through the seven statements:

| | | |
|---|---|---|
| 1 | <frameset col=50%> | /to frame depth 2/ |
| 2 | <frame src=doc1 name=“LEFT”> | /show doc 1 at depth 2/ |
| 3 | <frame src=“<frameset row=50%> | /to frame depth 3/ |
| 4 | <frame src=doc4> | /show doc 4 at depth 3/ |
| 5 | <frame src=doc5> | /show doc 5 at depth 3/ |
| 6 | </framset>”> | /to frame depth 2/ |
| 7 | </frameset> | /to frame depth 1/ |

Statement 1 is interpreted resulting in that the following statements relate to frame depth 2. Interpretation of statement 2 results in extraction of information regarding allowable frame depths for doc 1 and if doc 1 is allowed at frame depth 2, statement 3 is interpreted, otherwise the process is stopped. The interpretation of statement 3 results in that the following statements relate to frame depth 3. Interpretation of statement 4 and 5 results in that docs 4 and 5 are to be shown at depth 3 and it is checked whether this is allowed.

The check is made if a document is present at several frame depths. The difference in frame depth is calculated and compared to the allowed frame depth. If this number is exceeded the resulting page is not valid and no further processing should be made. There by the inherited problem of infinite unpacking of the worms are avoided.

If all checks where positively executed, the corresponding vda is constructed. This is done by extracting the identifiers from the seven statements and gather all the information in the vda.

(doc1, doc4, doc5; <frameset col=50% . . . /frameset>)

It should be noted that the execution sequence described above is not the only useable. For instance the frame depth check may be performed during, and not after/before the vda construction.

It should also be emphasised that use of the frame depth concept is, of course, not limited to be used in connection with virtual data arguments, but in this case a depth counter must be added to the browser in order to keep track of frame depths.

Implementation and Use of the Invention

In the following an implementation of the invention is disclosed. In particular a computer system adapted to carry out the method according to the invention is described in details. The new crawling algorithm comprises of a main algorithm that handles URL-list, picking one URL at the time out of the list and examines this URL by calling the Investigate_URL routine that may but more URL into the URL-List-. The URL-list is a global variable. In order to handle the frame depth problem a frame depth counter list FDC-List is introduced which is a global variable too. This list contains elements that consists of the URL and the minimum and maximum frame depth that the URL is found on.

The investigate URL procedure works like the Basic worm algorithm with one major exception and that is that if there is a test for frameset then this should be handled recursively by calling the Drill_Frameset procedure with the vda that is created from the source by the Generate_vda function. The Generate_vda procedure generates the VDA for the frameset.

The procedure Drill_Frameset works by investigating the frameset and while it does that it keeps track of the frame depth that the URL is found on. If the frame depth limit is exceeded the URL is dropped.

The procedure Drill_Frameset works recursively by calling Investigate_URL such that the URL's is found in the frameset does nor get into the normal URL-list but is handled immediately forwarding the framedepth.

It the described algorithm a number of improvement may be done, e.g in order to avoid reading the source more than once, typically done by jumping to a different branch if certain conduction is discovered. As example the crawler always assumes that a pages does not contain a frameset and if it encounters one it aborts and jumps to the frame handling line. Hence there does not have to be a deterministic test on the entire source of whether there is a frameset or not. This is for clarity of the algorithm not attempted displayed in the flowcharts.

1. A virtual data argument for virtual data, comprising
at least one identifier each uniquely identifying one or more items of the virtual data, and
at least one descriptor uniquely defining relation ship between the item(s) identified by the identifier(s).

2. A virtual data argument according to claim 1, wherein one or more of the at least one identifier(s) comprises document locator(s), such as URL(s).

3. A virtual data argument according to claim 1, wherein one or more of the descriptor(s) comprises a set of instructions, such as a container.

4. A virtual data argument according to claim 1, wherein the item(s) is(are) web-pages.

5. A virtual data argument according to claim 1, wherein at least one of the at least one identifier(s) is a virtual data argument.

6. A method of generating a virtual data argument for virtual data, said virtual data argument being characterised in that
the virtual data and/or its content can be constructed from it's virtual data argument, and
the virtual data can be identified by the virtual data argument,
said method comprising conjunction of at least one identifier identifying one or more item(s) of the virtual data and a descriptor uniquely defining relation ship between the item(s) identified by the identifier(s).

7. A method according to claim 6, further comprising the step of progressing, preferably by use of a worm or the like, through a collection of data items, such as documents, and examining some or all of said data items for descriptors and if the examining reveals at least one descriptor a virtual data argument is generated corresponding to said descriptor(s) and the corresponding data items.

8. A method according to claim 6, further comprising the step of following all or some links, if present, in the collection of data items and examining data items corresponding to said links for descriptors and if the examining reveals at least one descriptor.

9. A method according to claim 6, further comprising the step of storing said virtual data argument.

10. A method according to claim 6, further comprising the step of examining a virtual data argument for links and if the examining reveals a link a virtual data corresponding to the virtual data being the result of executing said link is generated.

11. A method according to claim 10, wherein, when the examining reveals a link, the virtual data argument and the link is stored in a list of not yet created virtual data arguments.

12. A method according to claim 11, wherein virtual data arguments for the virtual data arguments and corresponding links stored in the list of not yet created virtual data arguments are generated after progressing of the collection is ended.

13. A method according to claim 1, further comprising the step of examining for virtual data argument having identical descriptors and for such virtual data arguments examining whether the identifier parts contains permutations of the same identifier and in confirmative case taking measures to assure that only one of those virtual data arguments is available, for instance by only storing one of those virtual data arguments.

14. A method according to claim 6, wherein the virtual data argument is characterised by one or more of the features according to claim 1.

15. A method for constructing a list of virtual data arguments, comprising:
providing a first virtual data argument to a first virtual data;
constructing the first virtual data and/or it's content;
extracting, if present, identifier(s) to data item(s) from the first virtual data and/or it's content;
providing a descriptor describing the context of the identifier(s) to data item(s);
conjugating identifier(s) to data item(s) and the corresponding descriptor thereby defining a second virtual data; and
assigning a virtual data argument to the second virtual data.

16. A method according to claim 15, comprising one or more of the steps according to claim 6.

17. A method according to claim 16, wherein generation of virtual data arguments comprises crawling through each data items and follow the link(s) present in data items.

18. A method according to claim 17, wherein in case data item being meta-data then an absolute reference to the detected virtual data is recorded.

19. A method according to claim 18, wherein further comprising checking whether a virtual data argument to a virtual data has been recorded.

20. A method for controlling the display of one or more documents in frames within a page, which display being dictated by a set of commands, said method comprising
detecting whether execution of a command of said set of commands results in splitting a frame into two or more frames,
and in confirmative case
assign a frame depth identifier to each of the frames into which the original frame are split.

21. A method according to claim 20, further comprising the step of
detecting whether a document dictated to be displayed at a particular frame depth is allowed to be displayed at said frame depth.

22. A method according to claim 20, wherein said frame depth identifier is a number being increased by one each time a frame is split.

23. A method according to claim 20, wherein said splitting detection comprising detecting while the commands in the set of commands are executed.

24. A method according to claim 20, wherein said splitting detection comprising detecting before the commands in the set of commands are executed.

25. A method according to claim 21, wherein a positive detection of allowance for all commands of the set of commands results in that a virtual data argument (VDA) corresponding to the set of commands is constructed.

26. A method according to claim 21, where a negative detection of allowance for one of the commands of the set of commands results in that the method is terminated.

27. A method according to claim 20, further comprising, in case a document is dictated to be displayed at several frames, checking whether the difference in frame depth is allowed.

28. A method according to claim 20, wherein the commands comprised in the set of commands are executed sequentially.

29. An computer system for generating a virtual data argument for virtual data, said virtual data argument being characterised in that
the virtual data and/or its content can be constructed from ifs virtual data argument, and
the virtual data can be identified by the virtual data argument,
said apparatus comprising means, such as computer processing means, for conjunction of at least one identifier identifying one or more item(s) of the virtual data and a descriptor uniquely defining relation ship between the item(s) identified by the identifier(s).

30. An computer system according to claim 29, further comprising means for executing one or more of the steps defined in claim 7.

31. A computer system for constructing a list of virtual data arguments, comprising:
means, such as computer processing means, for providing a first virtual data argument to a first virtual data;
means, such as computer processing means, for constructing the first virtual data and/or it's content;
means, such as computer processing means, for extracting, if present, identifier(s) to data item(s) from the first virtual data and/or it's content;
means, such as computer processing means, for providing a descriptor describing the context of the identifier(s) to data item(s);
means, such as computer processing means, for conjugating identifier(s) to data item(s) and the corresponding descriptor thereby defining a second virtual data; and
means, such computer processing means, for assigning a virtual data argument to the second virtual data.

32. A computer system according to claim 31, further comprising means, such as computer processing means, for executing one or more of the steps defined in claim 15.

33. A computer system for controlling the display of one or more documents in frames within a page, which display being dictated by a set of commands, said computer system comprising
detecting means, such as computer processor means, for detecting whether execution of a command of said set of commands results in splitting a frame into two or more frames,
and computer processor means instructed to, in confirmative case,
assign a frame depth identifier to each of the frames into which the original frame are split.

34. An apparatus according to claim 33, further comprising means, such as computer processing means, for executing one or more of the steps defined in claim 20.
